(19) United States
(12) Patent Application Publication
(10) Pub. No.: US 2015/0136255 A1
(43) Pub. Date: May 21, 2015

(54) PIPE HAVING SLITS

(71) Applicants: Seth HARDING, Hamilton, OH (US); William Shaffer, West Chester, OH (US); Kris Sayre, Alexandria, MN (US)

(72) Inventors: Seth HARDING, Hamilton, OH (US); William Shaffer, West Chester, OH (US); Kris Sayre, Alexandria, MN (US)

(73) Assignee: ADVANCED DRAINAGE SYSTEMS, INC., Hilliard, OH (US)

(21) Appl. No.: 14/084,134

(22) Filed: Nov. 19, 2013

(51) Int. Cl. B05B 1/20; A01G 25/06; E03F 1/00; A01G 25/02; F16L 11/15; E02B 11/00

(52) U.S. Cl. CPC B05B 1/20; F16L 11/15; E02B 11/005; E03F 1/00; A01G 25/02; A01G 25/06
USPC 137/602

(57) ABSTRACT

A pipe is disclosed. The pipe may comprise an inner wall, an outer wall coupled to the inner wall and including a plurality of corrugation crests and a plurality of corrugation valleys, and a plurality of slits positioned within the corrugation valleys, wherein the slits may be evenly spaced relative to each other around an entire circumference of the pipe.

### FIELD OF THE DISCLOSURE

The present disclosure relates to a pipe, and more particularly, a dual-wall, corrugated pipe having narrow slits.

### BACKGROUND OF THE DISCLOSURE

Generally speaking, drainage systems may employ corrugated pipes to collect and convey fluids to desired locations in various agricultural, residential, recreational, or civil engineering and construction applications. Such a corrugated pipe may include a smooth, inner pipe wall defining a channel and an outer pipe wall having a plurality of corrugation crests and valleys. In addition, the corrugated pipe may include a plurality of slots or slits extending through the outer and inner pipe walls to facilitate the drainage of fluid surrounding the pipe. The fluid may enter the pipe channel through the plurality of slots or slits and may be conveyed to the appropriate discharge location.

In some instances, the corrugated pipe may be buried underground or otherwise surrounded by bedding material, such as soil, sand, dirt, stone, concrete, and the like. While fluid surrounding the pipe may be conveyed through the plurality of slits, debris and other particulates, such as fine sand and dirt, may also enter the pipe channel through the plurality of slits. The debris and particulates may accumulate in the pipe channel, interrupting and/or blocking the flow of fluid through the pipe.

One contemplated remedy for such an undesired entry of particulates through the plurality of slits includes wrapping the pipe with an appropriate filter material, such as, for example, a geotextile fabric, The filter material may include an appropriate porosity that allows fluid to permeate therethrough but blocks particulates from reaching the pipe. Such an application may, however, have certain limitations. For example, the filter material may impede fluid flow to the plurality of slits of the pipe. Fitting a drainage pipe with the filter material may also be cumbersome, time consuming, and result in inefficiencies relating to transport and installation of drainage applications. Moreover, wrapping the pipe with a filter material requires additional costs, labor, and parts to any drainage application.

Accordingly, the slitted pipe of the present disclosure is directed to improvements in the existing technology.

### SUMMARY OF THE DISCLOSURE

In one aspect of the disclosure, a pipe may comprise an inner wall, an outer wall coupled to the inner wall and including a plurality of corrugation crests and a plurality of corrugation valleys, and a plurality of slits positioned within the corrugation valleys, wherein the slits may be evenly spaced relative to each other around an entire circumference of the pipe.

In another aspect of the disclosure, a pipe may comprise an inner wall, an outer wall coupled to the inner wall and including a plurality of corrugation crests and a plurality of corrugation valleys, and a plurality of slits positioned within the corrugation valleys, wherein slits in adjacent valleys may be substantially aligned relative to each other along a length of the pipe.

In yet another aspect of the disclosure, a pipe may comprise an inner wall, an outer wall coupled to the inner wall and including a plurality of corrugation crests and a plurality of corrugation valleys, a channel defined by the inner wall, and a plurality of slits extending through the outer and inner walls into the channel, wherein each slit may include a width ranging between approximately 0.005 inch and 0.020 inch.

### BRIEF DESCRIPTION OF THE DRAWINGS

FIG. 1 is a perspective view of a corrugated pipe according to an exemplary disclosed embodiment;

FIG. 2 is another view of the corrugated pipe of FIG. 1 according to an exemplary disclosed embodiment;

FIG. 3 is an expanded view of a portion of the corrugated pipe indicated by the circle “B” in FIG. 2 according to an exemplary disclosed embodiment: and

FIG. 4 is a cross-sectional view of the corrugated pipe taken along dashed line “A-A” of FIG. 2 according to an exemplary disclosed embodiment.

### DETAILED DESCRIPTION

Reference will now be made in detail to the exemplary embodiments of the present disclosure described above and illustrated in the accompanying drawings.

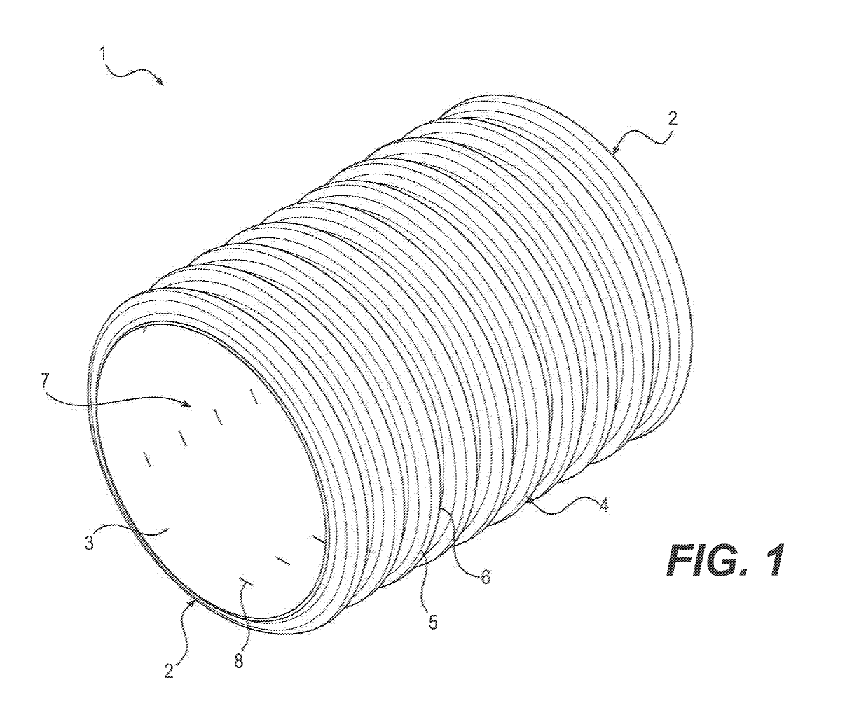

FIG. 1 illustrates a perspective view of an exemplary corrugated pipe 1. Corrugated pipe 1 may be configured to collect, transport, and drain a fluid to an appropriate location. In one embodiment, pipe 1 may be a subterranean drainage pipe disposed below a surface of a ground, such as a road, sidewalk, or lot, and may be employed to drain excess rain or groundwater from the ground to an appropriate discharge point, such as a canal, river, lake, ocean, or treatment facility. It should be appreciated, however, that the details of the disclosed pipe may be applicable in various other drainage settings. For example, pipe 1 may be utilized in connection with agriculture, mining, sewage disposal, a storm sewer, a turf or recreational field, the timber industry, landfill and waste disposal, road and highway drainage, and residential and commercial drainage applications for transporting and draining various types of fluid.

Corrugated pipe 1 may be a dual-wall, corrugated pipe including openings 2, an inner wall 3, and a corrugated outer wall 4. In one embodiment, inner wall 3 and corrugated outer wall 4 may be co-extruded. Inner wall 3 and corrugated outer wall 4 then may be molded together in a corrugator. Alternatively, inner wall 3 may be separately fused to corrugated outer wall 4.

As illustrated in FIG. 1, inner wall 3 may be substantially smooth and may define a channel 7 of corrugated pipe 1, Moreover, corrugated outer wall 4 may include a plurality of corrugation crests 5 and corrugation valleys 6. Corrugated pipe 1 may also include a plurality of drainage slots or slits 8. Drainage slits 8 may be configured to convey fluid, such as liquid or air, into corrugated pipe 1 and may then be transported by corrugated pipe 1. For example, in an agricultural application, corrugated pipe 1 may be buried underground and surrounded by soil, sand, or gravel. Groundwater, or any other fluid in the ground, may enter corrugated pipe 1 through drainage slits 8. The groundwater or other fluid may be collected in channel 7 of corrugated pipe 1 and delivered to an appropriate discharge point, such as a ditch, pond, or lift station. Drainage slits 8 may be formed on corrugated pipe 1 by any suitable means. For example, once corrugated outer wall 4 and inner wall 3 are coupled together, sections of corrugated pipe 1 may be removed and/or cut to form drainage slits 8. In some embodiments, a knife plunge or a saw blade may be utilized to cut sections of corrugated pipe 1 to form drainage slits 8. In some embodiments, corrugated pipe 1 may include a bell end section or a spigot end section. In certain other embodiments, corrugated pipe 1 may be extruded to include in-line bell and spigot sections, as disclosed in co-pending application Ser. No. 12/272,075, which is incorporated herein by reference in its entirety.

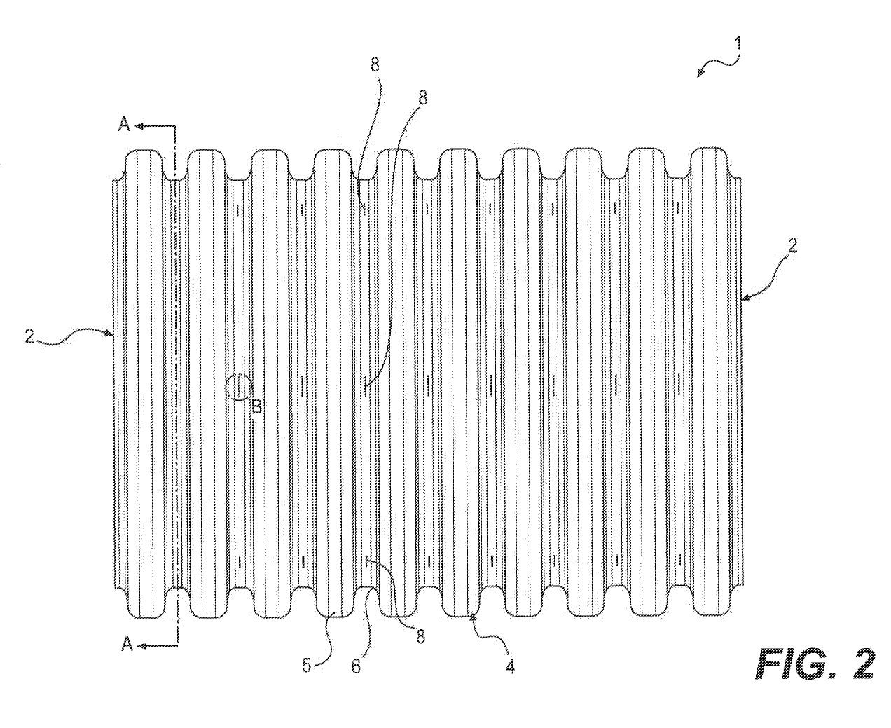

FIG. 2 illustrates another view of the corrugated pipe 1 according to an exemplary disclosed embodiment. As shown in FIG. 2, drainage slits 8 may be positioned within corrugation valleys 6. Fluid may be collected within corrugation valleys 6 and may drain through drainage slits 8, into channel 7 of corrugated pipe 1. In some embodiments, drainage slits 8 in adjacent corrugation valleys 6 of corrugated pipe 1 may be substantially aligned axially relative to each other along a length of corrugated pipe 1. It should be appreciated, however, that in other embodiments, drainage slits 8 in adjacent corrugation valleys 6 of corrugated pipe 1 may not be aligned axially relative to each other along the length of corrugated pipe 1. That is, drainage slits 8 in adjacent corrugation valleys 6 of corrugated pipe 1 may be positioned in an axially staggered configuration relative to each other along the length of corrugated pipe 1. In yet other embodiments, drainage slits 8 may be configured in every other corrugation valley 6 along a length of corrugated pipe 1 in the axial direction. It should be appreciated that a repeating pattern of drainage slits 8 in corrugation valleys 6 may distribute fluid consistently and evenly into channel 7 of corrugated pipe 1.

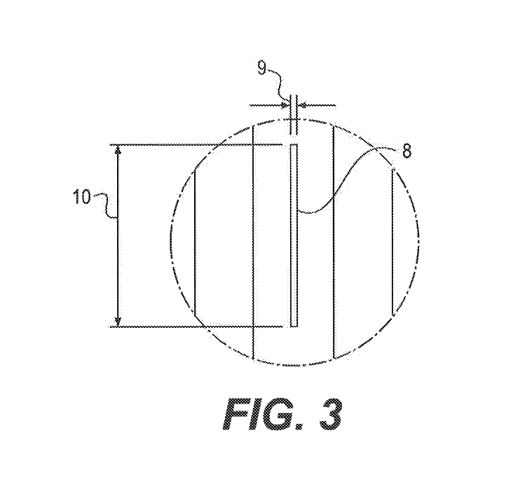

Drainage slits 8 may include appropriate dimensions to facilitate the entry of liquid into corrugated pipe 1, while preventing the entry of particulates, such as sand, dirt, soil, and the like. FIG. 3 illustrates an enlarged section “B” of corrugated pipe 1 shown in FIG. 2. As shown in FIG. 3, in certain embodiments, each drainage slit 8 may include a width 9 ranging between approximately 0.005 inch and 0.020 inch. Width 9 is measured longitudinally relative to corrugated pipe 1. This particular range for width 9 may provide certain advantages. For example, in many agricultural applications, width 9 ranging between approximately 0.005 inch and 0.020 inch may block the entry of particulates typically found in soil. As such, drainage slits 8 may facilitate the infiltration of fluid into pipe 1, while reducing and/or eliminating the collection and buildup of particulates in channel 7 that may impede the flow of fluid out of corrugated pipe 1. In some embodiments, each drainage slit 8 may include a height 10 ranging between approximately 0.5 inch and 3.0 inches. In other embodiments, each drainage slit 8 may include a height 10 of approximately 0.75 inch. Height 10 is measured along a circumference of corrugated pipe 1. Accordingly, each drainage slit 8 may include an infiltration area ranging between approximately 0.0025 inches² and 0.06 inches².

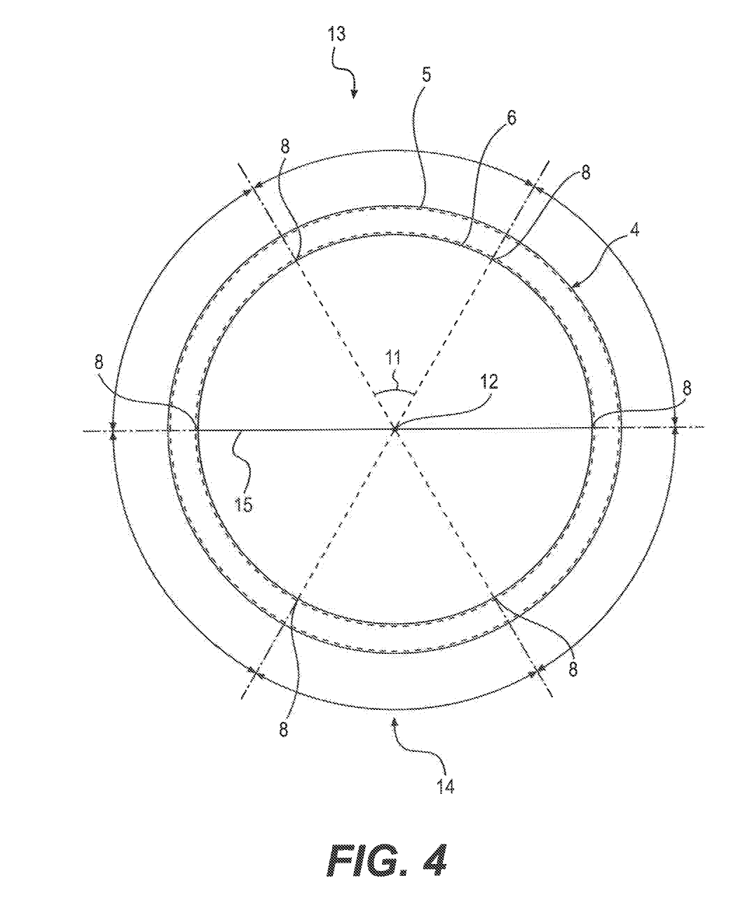

FIG. 4 illustrates a cross-sectional view of corrugated pipe 1 taken along line “A-A” of FIG. 2. As shown in FIG. 4, drainage slits 8 may be evenly spaced relative to each other around a circumference of corrugation valley 6. As alluded to above, a repeating pattern of evenly-spaced drainage slits 8 in corrugation valleys 6 may distribute fluid consistently and evenly into channel 7 of corrugated pipe 1. In some embodiments, six drainage slits 8 may be positioned in each corrugation valley 6. Each drainage slit 8 may be separated from adjacent slits by an appropriate angle 11 relative to a central axis 12 of corrugated pipe 1. In some embodiments, the angle 11 of separation between each drainage slit 8 may be approximately 60°. Drainage slits 8 may be positioned approximately 60° apart around the entire circumference of corrugation valley 6. Accordingly, corrugation pipe 1 may include drainage slits 8 on a top section 13 and a bottom section 14 of corrugated pipe 1.

In other embodiments, however, corrugation pipe 1 may include drainage slits 8 on opposing sides of corrugation pipe 1. That is, drainage slits 8 may not be positioned on top section 13 and bottom section 14 and may be positioned only on lateral side of corrugated pipe 1 relative to central axis 12. Such a configuration may provide the added benefit of preventing particulates and debris above and/or below corrugated pipe 1 from clogging drainage slits 8. In certain other embodiments, corrugation pipe 1 may include drainage slits 8 positioned only on bottom section 14 of corrugated pipe 1, and drainage slits 8 may be unevenly spaced relative to each other. In further embodiments, drainage slits 8 may be evenly spaced in corrugation valleys 6 around corrugation pipe 1 but may be unevenly distributed along corrugation pipe 1. That is, axial sections of corrugation pipe 1 may include drainage slits 8 positioned only on either top section 13, bottom section 14, or lateral sides of corrugation pipe 1.

It should also be appreciated that the number of drainage slits 8 positioned within each corrugation valley 6 may be less than or greater than six depending on, for example, the amount of drainage required and/or the infiltration area of each drainage slit 8. That is, more drainage slits 8 may be positioned in each corrugation valley 6 if the particular application of corrugated pipe 1 requires a high volume of fluid to be conveyed by pipe 1 and/or the infiltration area of each drainage slit 8 is relatively small. Moreover, it should be appreciated that the angle 11 of separation between each drainage slit 8 may be any angle as appropriate for the application and/or setting of corrugated pipe 1. If more than six drainage slits 8 are positioned within each corrugation valley 6 to, for example, facilitate greater drainage by corrugation pipe 1, the angle 11 of separation between each drainage slit 8 may be less than 60°. For instance, if twelve drainage slits 8 are positioned within each corrugation valley 6, the angle 11 of separation between each drainage slit 8 may be approximately 30° so that each drainage slit 8 may be evenly spaced relative to each other around the circumference of corrugation valley 6. On the other hand, if less than six drainage slits 8 are positioned within each corrugation valley 6 to, for example, accommodate less drainage by corrugated pipe 1, the angle 11 of separation between each drainage slit 8 may be greater than 60°. For instance, if five slits 8 are positioned within each corrugation valley 6, the angle 11 of separation between each drainage slit 8 may be approximately 72° so that each drainage slit 8 may be evenly spaced relative to each other around the circumference of corrugation valley 6.

As shown in FIG. 4, corrugated pipe 1 may also include an inner diameter 15 defined by inner wall 3. Inner diameter 15 may range between approximately 3 inches and 60 inches. The number of drainage slits 8 on corrugated pipe 1 may also vary depending on inner diameter 15 of corrugated pipe 1. For example, if inner diameter 15 is 12 inches, corrugated pipe 1 may include 36 drainage slits 8 per foot of length of corrugated pipe 1. If inner diameter 15 is 15 inches or 18 inches, corrugated pipe 1 may include 30 drainage slits 8 per foot of length of corrugated pipe 1. If inner diameter 15 is 21 inches or 24 inches, corrugated pipe 1 may include 24 drainage slits 8 per foot of length of corrugated pipe 1.

Furthermore, corrugated pipe 1 may include a drainage inlet area that may vary depending on inner diameter 15 of corrugated pipe 1. The drainage inlet area may be the total drainage area of corrugated pipe 1 defined by drainage slits 8. More specifically, the drainage inlet area may be the area of drainage slit 8 multiplied by the number of slits per foot of length of corrugated pipe 1. For example, in one embodiment, drainage slit 8 may include an area of 0.015 inches². For corrugated pipe 1 having inner diameter 15 of 12 inches and 36 drainage slits 8 per foot of length, the drainage inlet area may be approximately 0.54 inches² per foot of length of corrugated pipe 1. For corrugated pipe 1 having inner diameter 15 of 15 inches or 18 inches and 30 drainage slits 8 per foot of length, the drainage inlet area may be approximately 0.45 inches² per foot of length of drainage pipe 1. For pipe 1 having inner diameter 15 of 21 inches or 24 inches and 24 drainage slits 8 per foot of length, the drainage inlet area may be approximately 0.36 inches² per foot of length of corrugated pipe 1.

As will be appreciated by one of ordinary skill in the art, the presently disclosed corrugated pipe 1 may enjoy numerous advantages. First, drainage slits 8 may provide drainage through corrugated pipe 1, while preventing the entry of particulates, such as soil, sand, dirt, and the like, into corrugated pipe 1. The dimensions of drainage slit 8 may facilitate the infiltration of liquid into corrugated pipe 1 and may block particulates from entering and accumulating in channel 7 of corrugated pipe 1. In particular, width 9 of drainage slit 8 ranging between approximately 0.005 inches and 0.020 inches may be small enough to prevent entry of particulates and large enough to allow adequate fluid flow into channel 7 of corrugated pipe 1. Accordingly, corrugated pipe 1 may provide improved drainage of fluid because the buildup of particulates in channel 7 that disrupt fluid flow may be avoided. Second, corrugated pipe 1 may obviate the need for extra materials to prevent entry of particulates in corrugated pipe 1 during drainage applications. For example, corrugated pipe 1 may be used in drainage settings without a geotextile fabric wrapped around corrugated pipe 1 to block particulates. As such, fluid may directly be conveyed through drainage slits 8, improving drainage of fluid by corrugated pipe 1. Furthermore, the costs and labor associated with applying the excess materials, such as the fabric, may be avoided.

The many features and advantages of the present disclosure are apparent from the detailed specification, and thus, it is intended by the appended claims to cover all such features and advantages of the present disclosure which fall within the true spirit and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What claimed is:

1. A pipe, comprising:
an inner wall;
an outer wall coupled to the inner wall and including a plurality of corrugation crests and a plurality of corrugation valleys; and
a plurality of slits positioned within the corrugation valleys, wherein the slits are evenly spaced relative to each other around an entire circumference of the pipe.

2. The pipe of claim 1, wherein each slit is separated from adjacent slits in a corrugation valley by an angle relative to a central axis of the pipe.

3. The pipe of claim 2, wherein the angle separating adjacent slits is approximately 60°.

4. The pipe of claim 1, wherein each slit includes a width ranging between approximately 0.005 inch and 0.020 inch, wherein the width is measured longitudinally relative to the pipe.

5. The pipe of claim 4, wherein the width of each slit is approximately 0.005 inch.

6. The pipe of claim 4, wherein each slit includes a height ranging between approximately 0.5 inch and 3 inches, wherein the height is measured along the circumference of the pipe.

7. The pipe of claim 1, wherein each slit includes a drainage area ranging between approximately 0.0025 inches² and 0.06 inches².

8. The pipe of claim 1, wherein the pipe includes an inner diameter ranging between approximately 12 inches and 30 inches.

9. The pipe of claim 8, wherein the inner diameter is approximately 12 inches, and the pipe includes 36 slits per foot of length of the pipe.

10. The pipe of claim 8, wherein the inner diameter is approximately 15 inches, and the pipe includes 30 slits per foot of length of the pipe.

11. The pipe of claim 8, wherein the inner diameter is approximately 21 inches, and the pipe includes 24 slits per foot of length of the pipe.

12. The pipe of claim 1, wherein slits in adjacent valleys are substantially aligned in an axial direction relative to each other along a length of the pipe.

13. A pipe, comprising:
an inner wall;
an outer wall coupled to the inner wall and including a plurality of corrugation crests and a plurality of corrugation valleys; and
a plurality of slits positioned within the corrugation valleys, wherein slits in adjacent valleys are substantially aligned relative to each other along a length of the pipe.

14. The pipe of claim 13, wherein each slit includes a width ranging between approximately 0.005 inch and 0.020 inch, wherein the width is measured longitudinally relative to the pipe.

15. The pipe of claim 14, wherein the width of each slit is approximately 0.005 inch.

16. The pipe of claim 14, wherein each slit includes a height ranging between approximately 0.5 inch and 3 inches, wherein the height is measured along the circumference of the pipe.

17. The pipe of claim 13, wherein each slit includes a drainage area ranging between approximately 0.0025 inches² and 0.06 inches².

18. A pipe, comprising:
an inner wall;
an outer wall coupled to the inner wall and including a plurality of corrugation crests and a plurality of corrugation valleys;
a channel defined by the inner wall; and
a plurality of slits extending through the outer and inner walls into the channel, wherein each slit includes a width ranging between approximately 0.005 inch and 0.020 inch.

19. The pipe of claim 18, wherein the width of each slit is approximately 0.005 inch.

20. The pipe of claim 18, wherein each slit includes a drainage area ranging between approximately 0.0025 inches² and 0.06 inches².
